(19) United States
(12) Patent Application Publication
(10) Pub. No.: US 2024/0190729 A1
(43) Pub. Date: Jun. 13, 2024

(54) Method for Detecting an Abnormal Flow State in a Chlorine Generator

(71) Applicant: Aquacomfort Water Group, Delray Beach, FL (US)

(72) Inventor: Fernando Enrique Figueroa, Delray, FL (US)

(73) Assignee: Aquacomfort Water Group, Delray Beach, FL (US)

(21) Appl. No.: 18/077,649

(22) Filed: Dec. 8, 2022

(51) Int. Cl. C02F 1/467

(52) U.S. Cl. CPC C02F 1/4674; C02F 2001/46157; C02F 2303/04

(57) ABSTRACT

A system and method for using an electrolytic cell to detect an abnormal water flow state through the cell. The system applies a voltage across the electrodes in the cell and preferably waits until current through the cell has stabilized. The system then disconnects the voltage from the cell and begins measuring the floating voltage across the cell over time. A range of normal voltage decay intervals is determined for a flow state where water is flowing through the cell in an expected flow range. An abnormally low flow state will be detected as an abnormally long voltage decay interval.

### CROSS-REFERENCES TO RELATED APPLICATIONS

None.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to the field of electrolytic cells. More specifically, the invention comprises a method for detecting an abnormal flow state in a chlorine generator.

### 2. Description of the Related Art

The present invention is particularly well suited for use in a spa (also known as a “hot tub”). However, the invention may also be used in many other fields—such as pool filtration and chlorination systems, aqua culture systems, and water purification systems. It is beneficial to the reader's understanding to describe the use of the invention in one particular application. Accordingly, the invention's application to a spa will be described in detail. In reviewing these descriptions, however, the reader should bear in mind that the inventive method described has many other applications.

FIG. 1 depicts a prior art spa 10. Tub 12 is supported by chassis 14. Control panel 16 allows the user to control the operation of the spa by actions such as setting the temperature, switching on or off the circulation pump, and switching on or off various auxiliary jets.

Numerous components are contained within chassis 14. FIG. 2 provides a simplified representation of these components. The components are arranged in a line in order to aid visualization—though ordinarily the flow path from component to component will include several changes of direction in order to fit all the components within the available space.

In the particular spa depicted, skimmer 20 pulls in return water and water intake line 22 feeds this water to the intake of pump 24. Pump 24—which is driven by an electric motor—increases the water pressure and discharges the flow through water discharge line 26. The water next flows through heater 30. Heater 30 includes resistive heating elements that selectively heat the water as it flows through.

The water leaving heater 30 next flows into filter 36. The filter removes particulate matter before feeding the flow to chlorine generator 38. The particular type of chlorine generator shown in FIG. 3 is an electrolytic cell that generates chlorine from sodium chloride dissolved in the moving water. Such devices are synonymously referred to as a salt cell, a salt generator, a salt chlorinator, or SWG. The electrolytic cell creates electrolysis in the presence of dissolved sodium chloride in order to produce chlorine gas or its dissolved forms (hypochlorous acid and sodium hypochlorite). Significantly, the process also produces hydrogen gas.

The electrolytic cell itself consists of parallel conductive plates coated with a catalyst. Titanium is often used for the plates, with ruthenium or iridium being a common catalyst. The plates may be expanded into a mesh in order to increase permeability and surface area. An electrolytic cell controller places a charge on the plates in order to operate the cell.

Water leaving chlorine generator 38 travels through return line 40 to distribution manifold 42. Numerous branch lines 44 connect distribution manifold 42 to return ports 46 mounted on the tub of the spa. Those skilled in the art will know that numerous other components are often found in a spa. As an example, a second pump may be used to provide aerated water to arrays of secondary jets. The illustration of components such as these is not necessary to the present description, but the reader should bear in mind that the present invention can be combined with any other spa component.

FIG. 2 shows spa controller 28, which in this example is located proximate heater 30. The spa controller preferably includes a processor and an associated memory. Control software is retrieved from memory and run by the processor in order to control the operation of the spa. Spa controller 28 communicates with control panel 16 in order to receive user inputs and display information to the user. The spa controller controls the operation of the other components shown. It switches on and off pump 24 (and varies the speed of the pump for units having that capability). The spa controller switches on heater 30 in order to regulate the temperature of the water in tub 12. The spa controller also provides a signal to chlorine generator 38—typically either a simple power signal that energizes the electrolytic cell or a control signal that causes a device within chlorine generator 38 to energize the electrolytic cell.

The reader will also note the presence of input temperature sensor 32 on the input side of the heater and output temperature sensor 34 on the heater output side. Both these temperature sensors are monitored by spa controller 28. FIG. 3 provides a block diagram depicting the control functions of spa controller 28. As shown in the diagram, the temperature sensors 32, 34 provide temperature information to the spa controller. The spa controller—in turn—controls the operation of pump 24 and chlorine generator 38.

The failure of pump 24 presents a significant problem for the operation of the spa—since water circulation ceases. A known issue is the continued operation of heater 30 when pump 24 is not forcing water through the system. This may boil the stagnant water contained within the heater—eventually destroying the heater and possibly some of the associated piping. Some prior art systems include a direct flow sensor—such as a turbine wheel generator—to detect a pump failure. The system of FIG. 3 infers the pump's operational state via measuring the water temperature coming into the heater (input temperature sensor 32) versus the water temperature emerging from the heater (output temperature sensor 34). If the pump is running and the heater is operating, then the water temperature on the output side of the heater should be higher than the water temperature on the input side. If this temperature difference is not seen, then the controller may be programmed to assume that a pump failure has occurred.

Of course, the temperature difference only occurs when the heater is operating. If the current spa temperature is at or above the desired water temperature (set by the user on control panel 16 or otherwise) then the circulation pump 24 will run for some intervals without the heater running. Chlorine generator 38 is generally set to run whenever the pump is running. If the pump fails when the heater is off, the spa controller may not detect the failure.

The spa controller may also fail to detect a pump failure because of a problem with the temperature sensors themselves. In other circumstances a clogged or partially clogged filter may produce low water flow, but still provide enough temperature difference between the sensors 32, 34 for the spa controller to assume a normal state. In short, the use of a differential temperature between the sensors 32, 34 as the sole source of monitoring the flow state can cause problems. This is particularly true for the operation of chlorine generator 38.

The present invention is preferably implemented as part of a salt-based chlorine generator. Such generators have been in use for many decades. They began in pool operations, where the plumbing (pump, filter, salt generator, etc.) is generally located above the water line of the pool. When the pump in a pool system is switched off (or fails), the water drains from the plumbing and is replaced by air. If a pump failure causes a chlorine generator to be inadvertently run while dry, this does not cause a significant problem. The air in the electrolytic cell of the chlorine generator is a dielectric and the cell simply does not operate. Spa plumbing systems are different, however.

Returning to FIG. 2, the reader will note that the spa plumbing is all below water level 18. When pump 24 is shut down, the water within the spa plumbing does not drain. Everything remains flooded. If chlorine generator 38 continues to run with no water flowing, chlorine gas and hydrogen gas will accumulate in the cell. The gas will also tend to spill out into the adjacent plumbing and displace the water in those regions as well.

As those skilled in the art will know, chlorine gas and hydrogen gas each present their own hazards. Hydrogen is highly flammable and chlorine is poisonous. Further, the mixture of these two gases can be ignited when subjected to an ultraviolet source (including sunlight or an arc). The use of a chlorine generator in a spa therefore introduces hazards that are not found when a similar electrolytic cell is used in a pool.

It is very important to shut off the electrolytic cell in a chlorine generator when the water within the cell is not flowing. In the prior art, control of the cell depends on the external spa controller and its determination of whether there is water flowing in other parts of the system. It would be better to sense water flow directly in the chlorine generator itself, and to shut down the electrolytic cell if the flow falls below a defined threshold. The present invention provides such a solution.

### BRIEF SUMMARY OF THE PRESENT INVENTION

The present invention comprises a system and method for using an electrolytic cell to detect an abnormal water flow state through the cell. The system applies a voltage across the electrodes in the cell and preferably waits until current through the cell has stabilized. The system then disconnects the voltage from the cell and begins measuring the floating voltage across the cell over time. A range of normal voltage decay intervals is determined for a flow state where water is flowing through the cell in an expected flow range. An abnormally low flow state will be detected as an abnormally long voltage decay interval.

The decay profile of the cell in a floating state will depend on many factors—including the salinity of the water, the input impedance of the voltage measuring device, and the level of contamination of the cell's electrodes. Thus, an optional embodiment records a series of floating voltage decay tests when the cell is in operation. A gradual change in the decay rate over time may be considered a result of changes other than a pump failure. However, a significant change in the decay rate over a short period of time will be considered a failure and the inventive system would then cease the operation of the electrolytic cell until water flow is restored.

### BRIEF DESCRIPTION OF THE SEVERAL VIEWS OF THE DRAWINGS

FIG. 1 is a perspective view, showing a prior art spa.

FIG. 2 is an elevation view, showing some of the plumbing components commonly found in a prior art spa.

FIG. 3 is a schematic view, showing a spa controller and the components the spa controller interacts with.

FIG. 4 is a perspective view, showing a chlorine generator made according to the present invention.

FIG. 5 is a perspective view, showing the chlorine generator of FIG. 4 from another vantage point.

FIG. 6 is a schematic view, showing the operation of a controller and H-bridge circuit in an embodiment of the inventive chlorine generator.

FIG. 7 is a schematic view, showing the operation of an H-bridge circuit in an embodiment of the inventive chlorine generator.

FIG. 8 is a schematic view, showing the operation of an H-bridge circuit in an embodiment of the inventive chlorine generator.

FIG. 9 is a schematic view, showing the operation of an H-bridge circuit in an embodiment of the inventive chlorine generator.

FIG. 10 is a schematic view, showing an electrolytic cell.

FIG. 11 is a conceptual view, showing the measurement of a voltage across an idealized capacitor.

FIG. 12 is a plot of voltage across a capacitor decaying over time.

FIG. 13 is a plot of floating voltage decaying over time in the method carried out by the present invention.

FIG. 14 is a logic flow diagram, showing an exemplary embodiment of the steps carried out by the inventive method.

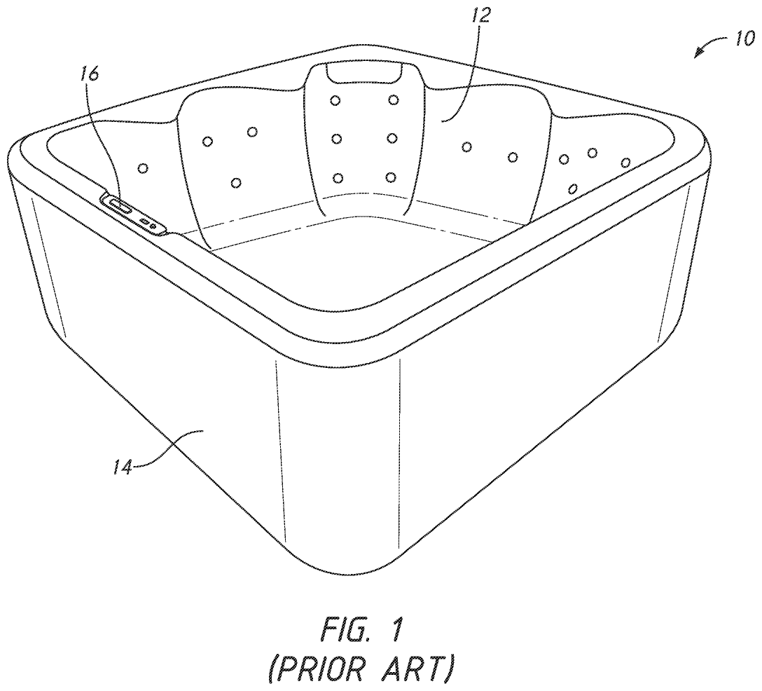

### REFERENCE NUMERALS IN THE DRAWINGS

10 spa
12 tub
14 chassis
16 control panel
18 water level
20 skimmer
22 water intake line
24 pump
26 water discharge line
28 spa controller
30 heater
32 input temperature sensor
34 output temperature sensor
36 filter
38 chlorine generator
40 return line
42 distribution manifold
44 branch line
46 return port
48 run signal
50 data signal
52 input
54 output
56 power supply
58 H-bridge circuit
60 electrolytic cell housing
62 electrolytic cell
64 electrolytic cell controller
65 processor
66 input voltage
67 memory
68 switch
69 input voltage
70 switch
72 switch
74 switch
76 step
78 step
80 step
82 step
84 step
86 step
88 step
90 step
92 step
94 step
96 step
98 sense lead
100 sense lead

### DETAILED DESCRIPTION OF THE INVENTION

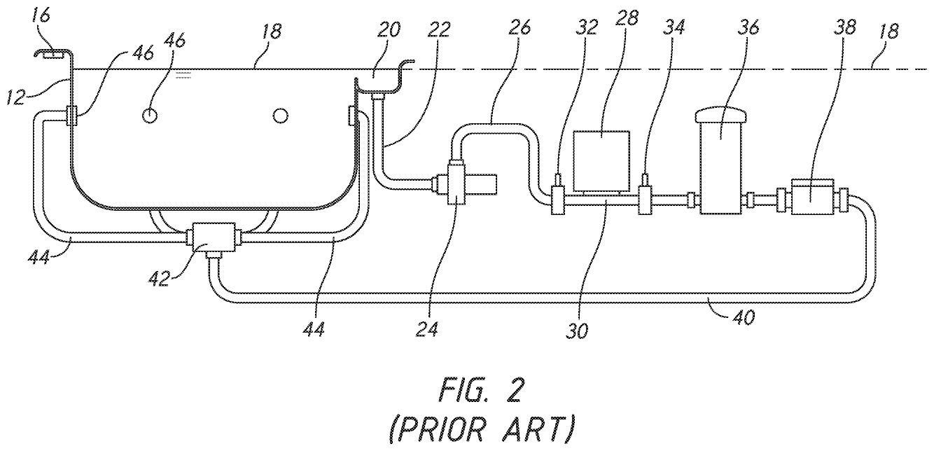

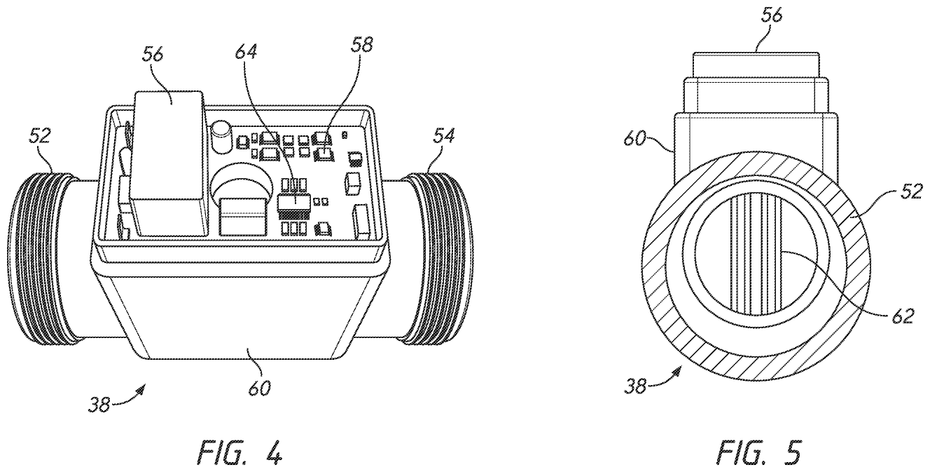

The location of the inventive chlorine generator 38 in an overall spa plumbing system is depicted in FIG. 2 and explained previously. Although the inventive method is applicable to a wide variety of chlorine generators, it is helpful to consider a representative physical embodiment. FIGS. 4 and 5 show one exemplary physical embodiment of the present invention. FIG. 4 shows chlorine generator 38. Input 52 connects the unit to incoming water flow and output $4 carries water out of the unit to the next component. Electrolytic cell housing 60 contains an electrolytic cell as well as control and power electronics. A housing cover is removed in FIG. 4 so that the reader can perceive the location of power supply 56, H-bridge circuit 58, and electrolytic cell controller 64. In the example shown, all these components are mounted on a single printed circuit board, though this obviously need not be the case for all embodiments.

FIG. 5 shows the same chlorine generator 38—looking in through input 52. Electrolytic cell 62 consists of a set of parallel conductive plates that are held in the path of the water flowing through the device. Some of these plates serve as anodes and some serve as cathodes. An electrolytic cell can be made using a single anode and a single cathode. However, in this example, multiple pairs of electrode plates are used. These pair are connected in parallel. Although the term “plate” is used for the electrodes, those skilled in the art will realize that the plate may be an expanded metal mesh. Non-planar shapes may also be used.

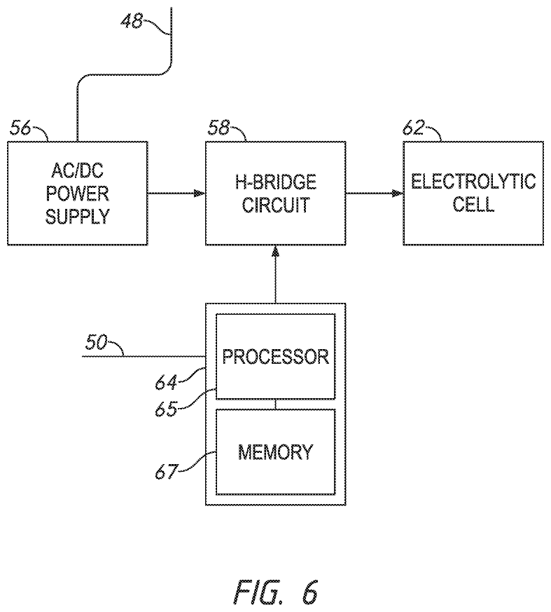

FIG. 6 provides a simplified block diagram for the electrical components contained within the embodiment of FIG. 5. Power supply 56 takes in alternating current—typically fed from a spa controller—and rectifies and preferably filters that current to create a suitable DC output. This DC output is fed into H-bridge circuit 58, which actually controls the electrical power fed to the electrolytic cell.

Electrolytic cell controller 64 preferably includes a processor 65 and an associated memory 67. Software for governing the operations of the controller is stored in memory and retrieved and run by the processor. Controller 64 controls the operation of H-bridge circuit 58, among other operations.

FIGS. 7-9 illustrate the operations of the H-bridge circuit 58 and the electrolytic cell controller 64. The function of an H-bridge circuit in a chlorine generator is well understood by those skilled in the art. H-bridge circuits are often used because it is advantageous to periodically reverse the polarity of the electrodes in an electrolytic cell in order to reduce the formation of deposits such as calcium.

FIG. 7 shows H-bridge circuit 58 feeding power to electrolytic cell 62. The electrolytic cell is not depicted in detail—but the reader will recall that it includes one or more electrode pairs configured to pass electrical current through water lying between each electrode pair. The water in this case includes a suitable amount of dissolved sodium chloride, so the water is conductive.

DC power from power supply 56 is split into positive voltage paths 66, 69—one on each side of the “H.” Each side of the H is also provided with a path to ground. The electrolytic cell bridges the middle of the H. Switches 68, 70, 72, 74 are controlled by electrolytic cell controller 64.

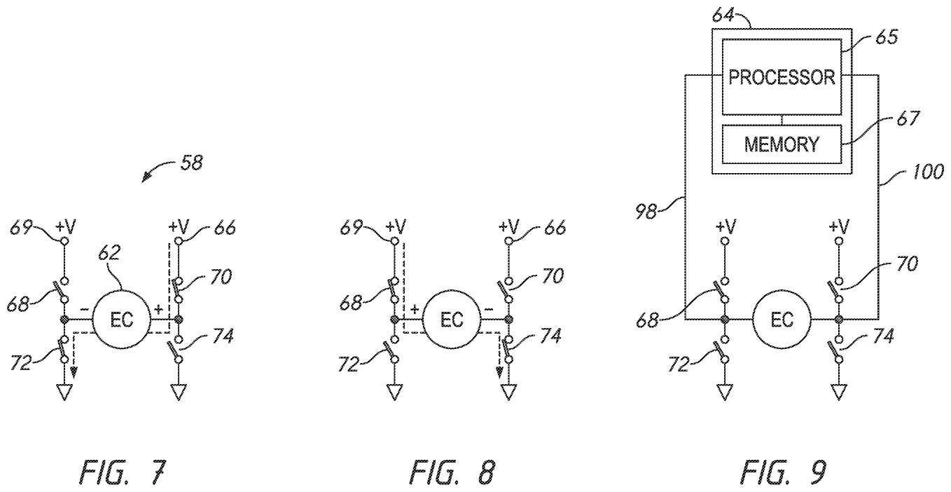

FIG. 7 shows a first configuration for switches 68, 70, 72, 74. Switches 70, 72 are closed while switches 68, 74 are open. This provides voltage across the electrolytic cell electrodes in a first polarity. FIG. 8 shows a second configuration—in which switches 68, 74 are closed while switches 70, 72 are open. This provides voltage across the electrolytic cell electrodes in the opposite polarity. When the cell is running, it is known to regularly switch back and forth between the configurations shown in FIGS. 7 and 8 in order to reduce the formation of deposits on the electrodes (such as calcium scale).

FIG. 9 shows a state in which the electrolytic cell controller has opened all four switches 68, 70, 72, 74. In this state no voltage is applied to the electrolytic cell. However—as will be explained in more detail subsequently—some voltage persists across the terminals of the electrolytic cell. This voltage—which is often referred to as a “floating voltage”—will decrease over time. While in the disconnected state shown in FIG. 9, two sense leads 98, 100 are applied across the electrolytic cell in order to measure the floating voltage. In the example shown, the processor in electrolytic cell controller 64 itself is used for the sensing operation.

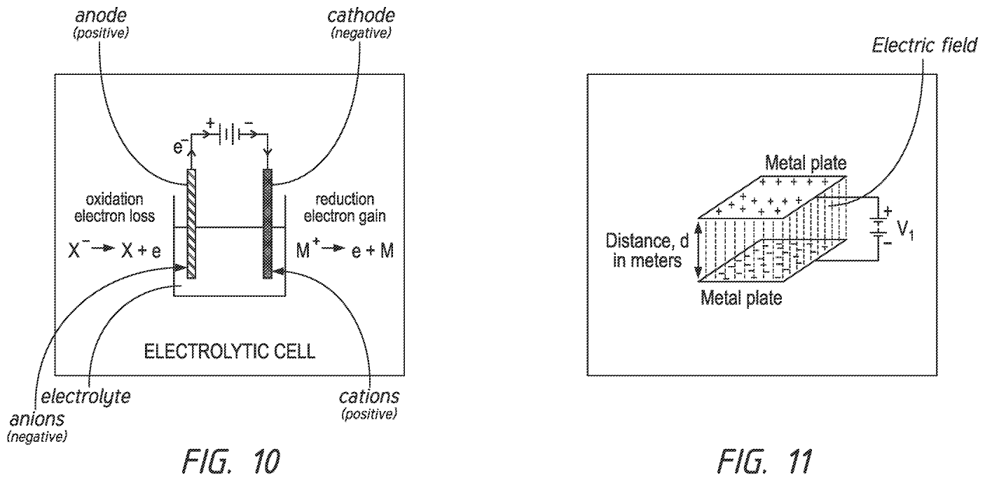

Evaluating the decay of the electrolytic cell's floating voltage over time allows the control to infer the flow state of the water passing through the electrolytic cell. FIGS. 10 and 11 conceptually illustrates the principles of operation. FIG. 10 provides a simple illustration of an electrolytic cell. An anode and a cathode (collectively “electrodes”) are immersed in a conductive solution (an electrolyte) and a voltage is applied across the anode and the cathode. The anode is positive, so it attracts anions (negative ions). The cathode is negative, so it attracts cations (positive ions). An oxidation reaction occurs proximate the anode, causing a flow of free electrons into the anode. A reduction reaction occurs proximate the cathode, causing the transfer of electrons into the electrolyte. The overall process thus described is commonly known as electrolysis. Applying a voltage across such an electrolytic cell produces a chemical reaction in the electrolyte. In the case of water containing dissolved sodium chloride, the chemical reaction produces chlorine gas (along with hypochlorous acid and sodium hypochlorite) and hydrogen gas—among other things.

Significant to the present invention, the electrolytic cell sown in FIG. 10 is also an energy storage device, defined by the equation:

C=εA/d,

where c is the capacitance, A is the area of the plates, ε is the absolute permittivity of the conductive material between the plates, and dis the distance between the plates.

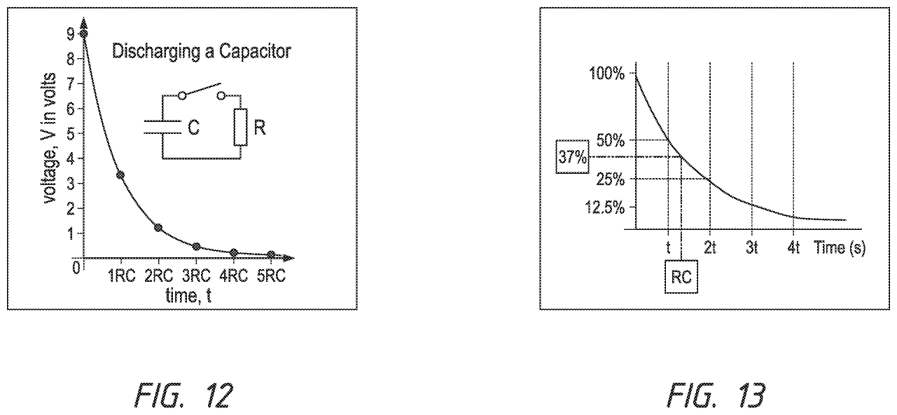

FIG. 12 depicts the discharge of an idealized capacitor over time through a simple loop circuit containing the capacitor and a resistor (a load). The capacitor voltage decays asymptotically over time. If all the conditions remain constant, then the decay will proceed along the function depicted each time.

Returning now to FIG. 9, the reader will recall that electrolytic cell controller 64 (or some other device) can be used to measure the floating voltage across the electrolytic cell once the driving voltage is removed. The significant conditions affecting the decay function include the input impedance of the controller circuit used to make the measurement, the resistance of the conductors forming the circuit to the electrolytic cell, and the speed of the water through the cell.

Water speed actually has a significant impact on the decay function. The decay of the floating voltage across the electrolytic cell proceeds much more slowly when the water is stagnant compared to when it is in motion. When the water is in motion, a fresh supply of ions is constantly propelled between the electrodes and the floating voltage between the two electrodes diminishes more rapidly than is the case with stagnant water. Thus, an algorithm can be run within the controlling software of the electrolytic cell controller to monitor for a sudden increase in an established decay time for the floating voltage. If such an increase is observed, the controller infers that an abnormal flow state exists (such as reduced flow or no flow) and responds.

FIG. 13 shows a plot of measured voltage versus time for a simple RC circuit. This generally proceeds according to the equation:

V_{c}=V₀e^{-t/RC}

Rather than compare the entire decay curve, it is helpful to have the algorithm measure a single point for comparison. As an example, the algorithm can measure a voltage at a fixed point in time after the driving voltage is removed from the electrolytic cell. Alternatively, the algorithm can regularly sample the floating voltage and the time, and then determine the amount of time needed to reach a defined voltage state.

In looking at the plot of FIG. 13 the reader will note that sampling the voltage within a certain range of values is likely to produce a more predictable and accurate result. As an example, one would not want to have the algorithm determine the time needed to exhaust most of the charge. Because the decay is an asymptotic function, the time required to lose the last bit of charge is very long. Likewise, one would not want to have an algorithm sample the time needed to lose the first bit of charge. The loss curve in that region is very steep, and a small sample error could thereby produce poor results.

FIG. 13 suggests that sampling near the middle of the curve is likely to produce the best results. In the example shown in FIG. 13, the algorithm is set to measure the amount of time required for the floating voltage to drop from its initial value to 37% of its initial value. This provides a sound measurement that can be performed by the electrolytic cell controller, with the result being stored and evaluated by the electrolytic cell controller.

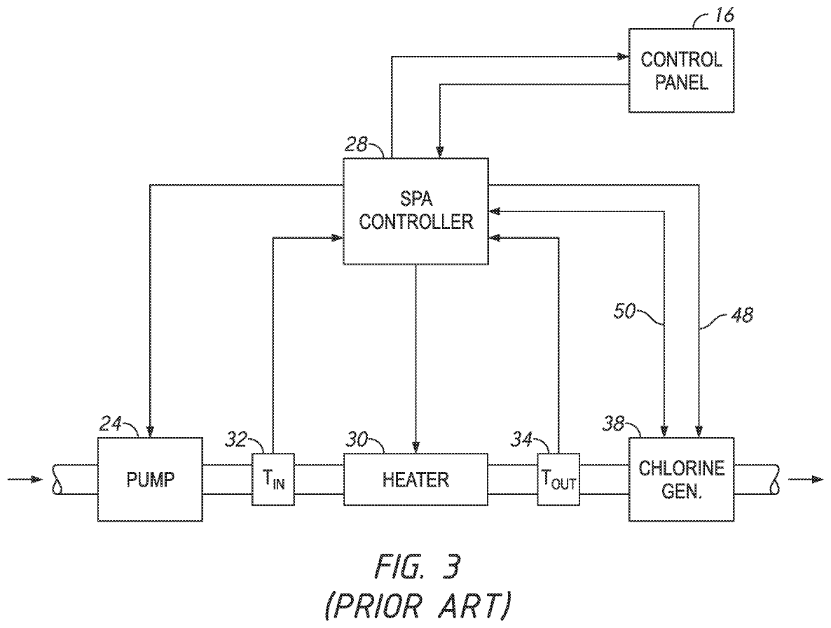

Returning briefly to FIG. 3, the reader will recall that the overall operation of the components in the spa is generally controlled by spa controller 28. The spa controller will ordinarily only run chlorine generator 38 when pump 24 is operating and water is circulating in the system. The electrolytic cell controller preferably performs the floating voltage decay evaluation regularly during its run periods. The electrolytic cell controller stores the results of the floating voltage evaluations in memory. It is preferable to average the results over time to eliminate short-term fluctuations. In this way the electrolytic cell controller correlates the decay in the floating voltage against a flow state of the water passing through the electrolytic cell. Because the chlorine generator is only active when the water is flowing, an initial assumption is made that the recent floating voltage evaluations correlate to a normal flow state (water passing through the chlorine generator at a normal rate).

If the cell controller at some later point runs a floating voltage decay evaluation and the decay occurs much more slowly, this will be assumed to correlate to an abnormal water flow state—such as no flow or significantly reduced flow. The electrolytic cell controller can then respond by shutting off power to the electrolytic cell. The electrolytic cell controller may also be configured to send a data signal back to the spa controller informing the spa controller of a probable flow failure (either as a result of the failure of the pump itself or excessive flow resistance from another source such as a clogged filter).

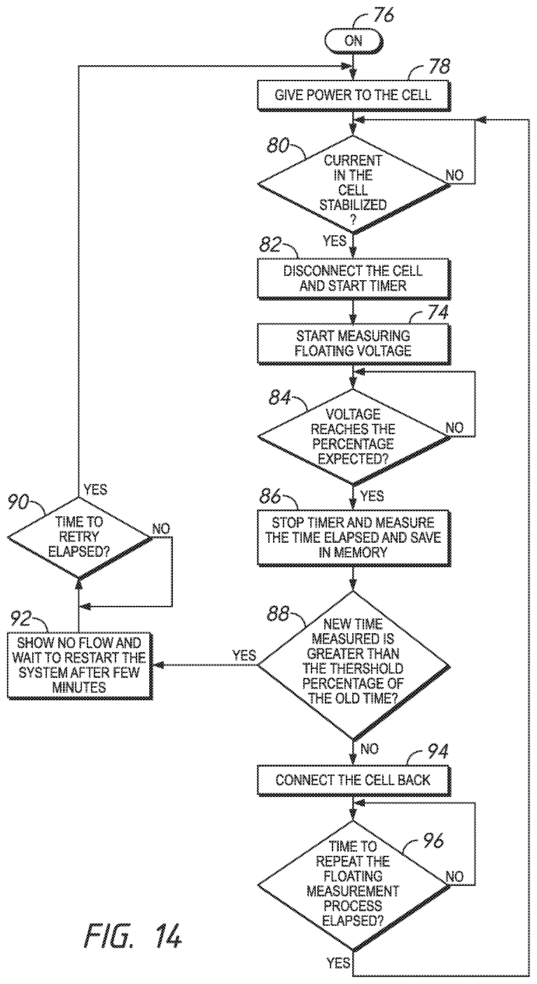

The evaluation algorithm performed by the controller can assume many forms, with all of these forms using the floating voltage decay to infer the water flow state. FIG. 14 depicts a representative depiction of the algorithm carried out by the electrolytic cell controller. The algorithm starts at step 76. Next, the electrolytic cell controller applies driving voltage to the electrolytic cell in step 78. In step 80 the controller evaluates the electrical current passing through the electrolytic cell to determine if the current has stabilized (indicating steady-state operation).

Once a steady current is observed, the algorithm moves to step 82—where the electrolytic cell controller disconnects the driving voltage to the electrolytic cell and starts the timer. The algorithm next moves to step 74. The electrolytic cell controller monitors the floating voltage across the electrolytic cell and continues to monitor the passage of time. This continues in step 84, with the algorithm monitoring until the floating voltage has decreased to a defined percentage of its original value. In this example, the floating voltage is monitored until it decreases to 37% of its originally measured value. The algorithm then notes the time required to reach 37% in step 86 (referred to as the “voltage decay time”).

The algorithm then proceeds to step 88, which compares the most recently determined voltage decay time against either the next most recent voltage decay time, a stored threshold value, or a stored average of recent voltage decay times (such as a rolling average). Step 88 preferably allows some variation, since some variation in the measured voltage decay time will naturally occur. As an example, step 88 will only trigger a determination of an altered flow state if the measured voltage decay time is more than 10% greater than the threshold value used. If the most recently measured voltage decay time is not more than 10% greater than the threshold value, then the algorithm moves to step 94 and driving voltage is again connected to the electrolytic cell.

The algorithm then proceeds to step 96, which introduces a delay interval before the voltage decay time is again tested. It is not necessary to continuously test the flow state. As an example, step 96 might only initiate a test once every 120 seconds. Once that time interval has elapsed, the algorithm returns to step 80 and starts another test cycle.

Returning now to step 88, if the algorithm determines that the voltage decay time has increased by more than 10% over the threshold value, the algorithm moves to step 92. A “no flow” signal is generated (whether there is zero flow or insufficient flow) and several actions then occur. At this time no driving voltage is being applied to the electrolytic cell (since floating voltage is being measured). The electrolytic cell controller continues to leave the cell disconnected from the driving voltage. The electrolytic cell also preferably sends a “no flow” message to the spa controller. Looking at FIG. 3, the reader will note that a data signal 50 can be set between the spa controller 28 and chlorine generator 38. In the case of a “no flow” state, the electrolytic cell controller in the chlorine generator sends the no flow signal to the spa controller. The spa controller may then react by removing pump power and heater power—as well as generating an error message that can be displayed to the user.

Looking again at FIG. 14, the algorithm moves on to step 90. In step 90 a waiting interval is initiated. The electrolytic cell controller takes no action until this interval has elapsed. This time interval may be made quite lengthy—such as 10 minutes. After the interval elapses, the algorithm returns to step 78 and initiates a new power cycle and test cycle.

### Example One

In this example, the algorithm uses a rolling average of the past three voltage decay times and the triggering event is the measurement of a new voltage decay time that is 1.10 times or greater than the rolling average. The following table shows the measurements leading up to a triggering event, along with the rolling average and the flow state determined by the algorithm:

| Sample Number | Voltage Decay t | Rolling Avg. | State |
|---|---|---|---|
| 124112 | 0.430 | 0.430 | NORMAL |
| 124113 | 0.424 | 0.432 | NORMAL |
| 124114 | 0.441 | 0.430 | NORMAL |
| 124115 | 0.418 | 0.432 | NORMAL |
| 124116 | 0.431 | 0.428 | NORMAL |
| 124117 | 0.440 | 0.430 | NORMAL |
| 124118 | 0.443 | 0.430 | NORMAL |
| 124119 | 0.851 | 0.430 | NO FLOW |

The use of averaging techniques is preferred in carrying out the inventive method. This is because many normal aspects of spa operation will cause variations. Examples include the deposition of solids on the electrolytic cell electrodes, variations in flow rates caused by varying filter back-pressure, and variations in the impedance of the floating voltage measurement circuit.

Of course, many different techniques can be used to detect a change in the voltage decay characteristics of the electrolytic cell during float, and thereby detect a change in the flow state. The most common decay characteristic will be the dropping of floating voltage over time, but there are many ways this can be monitored. The inventive method will measure floating voltage initially and assume that this correlates to normal flow. A change detected in the floating voltage characteristics (such as a lengthier decay period) will then be correlated to an abnormal flow state. Other possible methods of correlating floating voltage characteristics to a water flow state include:
1. Measuring a normal voltage decay interval when the electrolytic cell is first configured, storing that value in memory, and using that value as a threshold for abnormal flow state detection (including an additional offset—such as 10% over the threshold); and
2. Determining a normal floating voltage decay profile for all chlorinators of the same design and loading this value into the electrolytic cell controller at the factory.

Although the preceding descriptions present considerable detail they should be properly viewed as illustrating preferred embodiments of the present invention rather than limiting the scope of the invention. Many more embodiments following the same principles will occur to those skilled in the art. Accordingly, the scope of the invention should be fixed by the following claims rather than by the examples given.

Having described my invention, I claim:

1. A method for detecting an abnormal flow state in a chlorine generator, comprising:
(a) providing an electrolytic cell, including,
(i) an anode,
(ii) a cathode,
(iii) a passage for carrying salt-containing water, with said passage running at least in part between said anode and said cathode;
(b) applying a driving voltage across said anode and said cathode;
(c) removing said driving voltage across said anode and said cathode;
(d) measuring a floating voltage across said anode and said cathode over time; and
(e) correlating a decay in said floating voltage over time against a flow state of said salt-containing water in order to detect an abnormal flow state of said salt-containing water.

2. The method for detecting an abnormal flow state in a chlorine generator as recited in claim 1, further comprising:
(a) applying said driving voltage across said anode and said cathode until an electrical current through said anode and said cathode stabilizes; and
(b) after said current across said anode and said cathode stabilizes, then removing said driving voltage and measuring said floating voltage.

3. The method for detecting an abnormal flow state in a chlorine generator as recited in claim 1, further comprising:
(a) providing an electrolytic cell controller including a processor and an associated memory;
(b) providing software stored in said memory and configured to run on said processor, and
(c) wherein said processor performs said step of measuring said floating voltage.

4. The method for detecting an abnormal flow state in a chlorine generator as recited in claim 3, comprising:
(a) said processor periodically performing said steps of removing said driving voltage and measuring said floating voltage;
(b) said processor storing in memory a decay characteristic of said floating voltage over time, each time said floating voltage is measured; and
(c) said processor detecting said abnormal flow state by detecting a difference in a currently measured decay characteristic of said floating voltage compared to a decay characteristic of said floating voltage stored in memory.

5. The method for detecting an abnormal flow state in a chlorine generator as recited in claim 4, comprising:
(a) said processor using multiple instances of said decay characteristic stored in memory to create an average decay characteristic; and
(b) said processor detecting said abnormal flow state by detecting a difference in a currently measured decay characteristic compared to said average decay characteristic stored in memory.

6. The method for detecting an abnormal flow state in a chlorine generator as recited in claim 3, comprising said processor, upon detecting said abnormal flow state, shutting down said electrolytic cell.

7. The method for detecting an abnormal flow state in a chlorine generator as recited in claim 3, comprising:
(a) wherein said chlorine generator is in communication with a separate controller configured to control a pump that pumps water through said chlorine generator; and
(b) upon said detection of said abnormal flow state, said chlorine generator sends a signal to said separate controller indicating said abnormal flow state.

8. A method for detecting an abnormal flow state in a chlorine generator, comprising:
(a) providing an electrolytic cell, including,
(i) an anode,
(ii) a cathode,
(iii) a passage for carrying salt-containing water, with said passage running at least in part between said anode and said cathode;
(b) establishing a maximum decay interval;
(c) applying a driving voltage across said anode and said cathode;
(d) removing said driving voltage across said anode and said cathode;
(e) measuring a floating voltage across said anode and said cathode over time to determine a current decay interval; and
(f) determining an abnormal flow state when said current decay interval exceeds said maximum decay interval.

9. The method for detecting an abnormal flow state in a chlorine generator as recited in claim 8, further comprising:
(a) applying said driving voltage across said anode and said cathode until an electrical current through said anode and said cathode stabilizes; and
(b) after said current across said anode and said cathode stabilizes, then removing said driving voltage and measuring said floating voltage.

10. The method for detecting an abnormal flow state in a chlorine generator as recited in claim 8, further comprising:
(a) providing an electrolytic cell controller including a processor and an associated memory;
(b) providing software stored in said memory and configured to run on said processor; and
(c) wherein said processor performs said step of measuring said floating voltage.

11. The method for detecting an abnormal flow state in a chlorine generator as recited in claim 10, comprising:
(a) said processor periodically performing said steps of removing said driving voltage and measuring said floating voltage;
(b) said processor storing in memory a decay characteristic of said floating voltage over time, each time said floating voltage is measured; and
(c) said processor detecting said abnormal flow state by detecting a difference in a currently measured decay characteristic of said floating voltage compared to a decay characteristic of said floating voltage stored in memory.

12. The method for detecting an abnormal flow state in a chlorine generator as recited in claim 11, comprising:
(a) said processor using multiple instances of said decay characteristic stored in memory to create an average decay characteristic; and
(b) said processor detecting said abnormal flow state by detecting a difference in a currently measured decay characteristic compared to said average decay characteristic stored in memory.

13. The method for detecting an abnormal flow state in a chlorine generator as recited in claim 10, comprising said processor, upon detecting said abnormal flow state, shutting down said electrolytic cell.

14. The method for detecting an abnormal flow state in a chlorine generator as recited in claim 10, comprising:
(a) wherein said chlorine generator is in communication with a separate controller configured to control a pump that pumps water through said chlorine generator; and
(b) upon said detection of said abnormal flow state, said chlorine generator sends a signal to said separate controller indicating said abnormal flow state.

15. A method for detecting an abnormal flow state in a chlorine generator, comprising:
(a) providing an electrolytic cell, including,
(i) an anode,
(ii) a cathode,
(iii) a passage for carrying salt-containing water, with said passage running at least in part between said anode and said cathode;
(b) applying a driving voltage across said anode and said cathode;
(c) removing said driving voltage across said anode and said cathode;
(d) measuring a floating voltage across said anode and said cathode over time; and
(e) detecting a decreased rate of decay in said floating voltage as an abnormal flow state of said salt-containing water through said electrolytic cell.

16. The method for detecting an abnormal flow state in a chlorine generator as recited in claim 15, further comprising:
(a) applying said driving voltage across said anode and said cathode until an electrical current through said anode and said cathode stabilizes; and
(b) after said current across said anode and said cathode stabilizes, then removing said driving voltage and measuring said floating voltage.

17. The method for detecting an abnormal flow state in a chlorine generator as recited in claim 15, further comprising:
(a) providing an electrolytic cell controller including a processor and an associated memory;
(b) providing software stored in said memory and configured to run on said processor; and
(c) wherein said processor performs said step of measuring said floating voltage.

18. The method for detecting an abnormal flow state in a chlorine generator as recited in claim 17, comprising:
(a) said processor periodically performing said steps of removing said driving voltage and measuring said floating voltage;
(b) said processor storing in memory a decay characteristic of said floating voltage over time, each time said floating voltage is measured; and
(c) said processor detecting said abnormal flow state by detecting a difference in a currently measured decay characteristic of said floating voltage compared to a decay characteristic of said floating voltage stored in memory.

19. The method for detecting an abnormal flow state in a chlorine generator as recited in claim 18, comprising:
(a) said processor using multiple instances of said decay characteristic stored in memory to create an average decay characteristic; and
(b) said processor detecting said abnormal flow state by detecting a difference in a currently measured decay characteristic compared to said average decay characteristic stored in memory.

20. The method for detecting an abnormal flow state in a chlorine generator as recited in claim 17, comprising said processor, upon detecting said abnormal flow state, shutting down said electrolytic cell.
